(19) United States
(12) Patent Application Publication
(10) Pub. No.: US 2008/0263843 A1
(43) Pub. Date: Oct. 30, 2008

(54) REPAIR TOOL FOR USE WITH SPRING ACTUATED VALVE

(76) Inventor: Paul Gibbs, Midland, TX (US)

Correspondence Address: Merek, Blackmon & Voorhees, LLC, 673 S. Washington St., Alexandria, VA, 22314, US

(21) Appl. No.: 11/741,122

(22) Filed: Apr. 27, 2007

(51) Int. Cl. B23P 19/04

(52) U.S. Cl. 29/221.6

(57) ABSTRACT

Method of and apparatus for freeing a stuck valve in a valve assembly having a valve, a valve stem, and a valve operator connected to the valve stem. The apparatus comprises a tool having an enlarged head, an elongated shaft, and a bifurcated foot projecting at an acute angle from the elongated shaft. The bifurcated foot of the tool is placed abutting and straddling the valve stem, and in driving proximity to any enlargement of the valve stem, such as a return spring connector cap. An impact is applied to the enlarged head of the tool using a suitable striking tool such as a hammer. The impact is transferred to the valve stem, thereby unseating and freeing the valve.

### BACKGROUND OF THE INVENTION

1. Field of the Invention

The present invention relates to valves, and more particularly to apparatus for and method of freeing a stuck poppet type valve.

2. Description of the Prior Art

Valves are widely used to control flow of diverse fluids in industrial piping facilities. A frequently encountered type of valve is that having a spring or diaphragm actuated valve action, where the valve moves axially off its seat to open a conduit to flow under the control of pressure, spring action, or spring assisted action (e.g., a return spring). The valves may be normally open, partially closed or fully closed depending on the particular application. For instance, a valve may be a flow restriction valve continuously moving about a small range of flows, for example between 25% and 26.5% open throughout its life. In industrial practice, these valves are usually remotely controlled. While an electrical signal may be used, it is frequently the case that a pneumatic pressure based system is employed to operate the valve. In these latter cases, the valve includes a diaphragm operator for moving the valve from its seat to an open or closed position (or a position therebetween) responsive to a pneumatic signal. A return spring may be arranged to urge the valve into the closed (or open, depending on the type of valve or purpose of valve) position in the absence of the pneumatic signal.

This type of valve is subject to occasional failure due to sticking, especially in corrosive or unfiltered environments. The causes of valve sticking are diverse. The nature of the fluid being controlled, fluid or ambient temperatures, and latent defects of the valve, such as a bent stem, a nick or burr located on the stem, wear, overly tight packing, friction within the valve seat in combination with grit or other build up, may all cause a valve to stick in position so tightly that the pneumatic diaphragm operator and/or return spring may be insufficient to move the valve in the normal way.

The usual practice in typical industrial facilities is to have personnel engage the stem of the valve and apply impacts to free the stuck valve. This is frequently done with whatever tools and materials are readily at hand. Sometimes the tools used include screwdrivers, wrenches, hammers and other general purpose tools not configured to engage the valve securely and symmetrically and which are often damaged during the procedure. The other method of fixing the valve includes the very labor intensive method of disassembling the valve to diagnose and/or repair the problem. The prior art is in need of a suitable tool and method of freeing stuck valves.

### SUMMARY OF THE INVENTION

The present invention provides a tool for applying impacts to stuck valves, and a method of using this tool. The tool has an enlarged head for striking with a hammer, for example, an elongated shaft, and a bifurcated foot for stably and symmetrically engaging a valve stem. The bifurcated foot is arranged at an acute angle to the elongated shaft so that it may be advantageously maneuvered into engagement with the valve stem. This may be problematic in many cases since the return spring may obstruct ready access to the stem. The angle permits lateral insertion of the novel tool past spring coils, when present, so that the foot of the tool can straddle the stem and come to bear against a cap or other structure which connects the diaphragm to the stem. A hammer blow or the like may then be applied to the tool and resultant force is transmitted to the valve stem.

The acute angle of the bifurcated foot assures that the tool can be moved against the valve stem laterally, while still having the elongated shaft oriented such that force from the impact is transmitted in a mostly downward direction. This is desirable since most valves are designed so that the valve stem is vertically oriented and is located above the valve itself, so that downward movement opens the valve.

Applying force from impacts symmetrically about the valve stem avoids distorting the valve stem or damaging valve guiding structure and valve packing.

It is, therefore, an object of the invention to provide a suitable tool for engaging the stem of a stuck valve securely and symmetrically.

It is another object of the invention to be able to approach and engage the valve stem laterally while still being able to direct an impact in a mostly downward direction.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front elevational view of a tool for freeing a stuck valve according to one embodiment of the invention.

FIG. 2 is a side elevational view of the tool of FIG. 1.

FIG. 3 is a view of the tool of FIG. 1 in an operative position relative to a stuck valve to be freed.

FIG. 4 is a diagrammatic top plan detail view of engagement of the tool of FIG. 1 with the stem of the valve shown in FIG. 3.

FIG. 5 is a side perspective view of a representative valve of the type that can be freed by using the tool of FIG. 1.

### DETAILED DESCRIPTION OF THE PREFERRED EMBODIMENTS

Turning first to FIG. 5, a typical industrial valve assembly 2 that has become stuck is illustrated. While the type of valve shown is not part of the invention, an exemplary valve 2 is shown that is typically partially of fully open to control the rate or pressure of flow through the valve. Technically, the valve is only that part of valve assembly 2 that obstructs flow, and cannot be seen from the outside. Therefore, the term “valve assembly” will be understood to include supporting and surrounding structure of the valve, typically taking the form of a cast metallic housing 4 in which is formed fluid flow passages and a valve seat (not separately shown). Valve assembly 2 includes a valve stem 6 which when moved upwardly, moves the valve to an open (or more open) position, thereby enabling flow (or greater flow) through valve assembly 2. The valve stem 6 is contained within a valve guide defined by the lower valve housing encasing the valve and valve seat, struts 10, 12 and a valve operator opposite the valve seat. An opening (not shown) at the upper end of the valve guide connects the valve stem to a valve operator.

In the example shown, the valve operator comprises a pneumatic operator 8 typically including a diaphragm (concealed within) is supported on two struts 10, 12 above the end of valve stem 6. However, the invention is not limited to the type of operator and is not required for the operation of the invention, in that the valve could have no operator. A spring 14 is provided to return the valve to the open (or closed) position in the absence of a pneumatic signal which, if present, would cause pneumatic operator 8 to move the valve to the open position. Spring 14 acts on valve stem 6, being mechanically connected thereto by a spring retaining cap 16. Although this is not visible in FIG. 5, retaining cap 16 connects to valve stem 6 typically by engagement with suitable clips, which engage an inwardly projecting groove (clips and groove not visible in FIG. 5) formed in valve stem 6.

Retaining cap 16 with its associated clips may be regarded as an enlargement formed in valve stem 16. The purpose of this enlargement is to provide an interfering surface which entraps spring 14 and transfers spring force to valve stem 6. The present invention also may utilize the enlargement for the purpose of receiving impacts by personnel who must free the stuck valve. Enlargements may be provided by other elements of a valve. For example, it is possible that some valves have exposed diaphragm connection structure (not shown) which would project outwardly from valve stem 6 in a way analogous to that of retaining cap 16. It is conceivable that some valves have been fabricated or may in the future be fabricated to include an enlargement 17 providing a stable seat for receiving a valve unsticking tool. For the purposes of the present invention, all structure which projects radially outwardly from a narrower portion of a valve stem will be called an enlargement. Additionally, one skilled in the art, would recognize that a narrowed portion of the valve stem 19 could provide a detent for receiving the valve unsticking tool for the same purposes as the enlargement. In this case, the enlargement could be the portion immediately above or below the narrow portion. One skilled in the art would recognize that any device which provides a seat for the receiving the valve unsticking tool could be used. Additionally, a clamp or other temporary projection or removable object could be provided to provide a temporary seat for receiving the valve unsticking tool. One skilled in the art would also recognize that a valve that does not require a return spring could also mate with the valve tool of the present invention through an enlargement 17 or narrowing 19 to take advantage of the teaching of the present invention as described herein.

Valve assembly 2 is shown in a conventional orientation relative to an industrial or other piping installation. It will be recognized that the actual position of valve assembly 2 could be changed from that depicted herein. For purposes of describing the invention, and not by way of limitation, description will refer to the orientation shown and described. However, it is to be understood that orientational terms such as “up”, “upper”, “down”, “lower”, “vertical”, “horizontal”, etc., refer to directions as seen in the depictions of the various drawing figures which are referenced in textual description. Obviously, these orientations change with the position of a valve (e.g., valve) within its environment. Therefore, it will be understood that these orientational terms are introduced for semantic convenience, and should not be taken as literal conditions for practicing the invention.

It will be seen that a gap exists above retaining cap 16 and below pneumatic operator 8, with valve stem 6 occupying the gap. This gap affords the most practical access to the valve stem short of disassembling valve assembly 2, and is employed in the novel method as well as in typical prior art methods using ad hoc tools and materials.

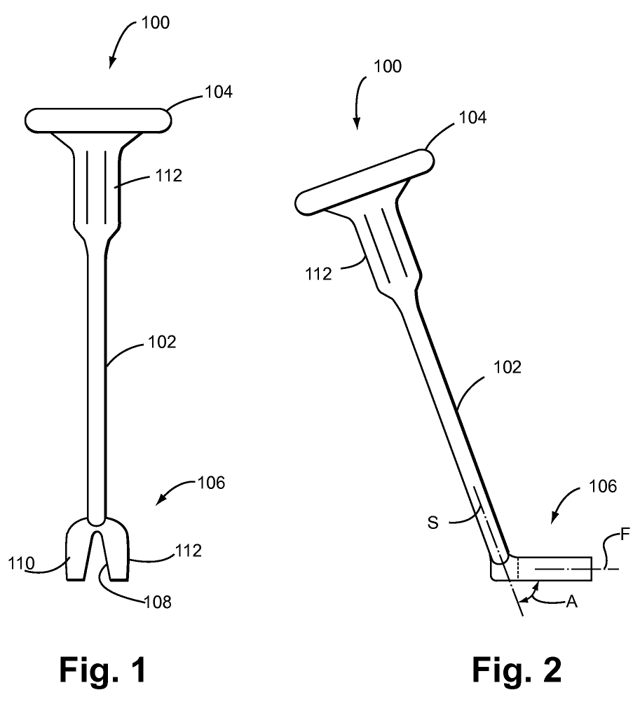

Turning now to FIGS. 1 and 2, tool 100 is shown. Tool 100 includes an elongated shaft 102 to which are fixed at one end, an enlarged head 104 for receiving impacts, and at the opposite end a bifurcated foot 106. Bifurcated foot 106 has an opening 108 formed between two mirror image tines 110, 112, but may have a different configuration to mate with particular valve stems, etc. Opening 108 is preferably V shaped to accommodate valve stems of different diameters. Opening 108 and tines 110, 112 are configured so that bifurcated foot 106 is symmetrical about opening 108 and along longitudinal axis F. In the most preferred embodiment, the overall length of the tool is between ten and sixteen inches in length, though the size may be smaller or larger depending on the application, need for portability, etc.

Preferably, tool 100 includes transitional reinforcing elements 112 such as ribs or fins for preventing enlarged head 104 from being altered from its generally perpendicular orientation to elongated shaft 102, as might result over time from impacts during repeated use.

Referring particularly to FIG. 2, longitudinal axis S of elongated shaft 102 is arranged at an acute angle A to longitudinal axis F of bifurcated foot 106. Providing an acute angle allows the force of any impact to be generally distributed downwardly to free the valve while minimizing forces perpendicular to the valve, which could damage the valve by, for example, bending the valve shaft. In the most preferred embodiment, this angle A is in the range of 50 to 80 degrees, but may be larger or smaller depending on the particular application and configuration of the valve, etc.

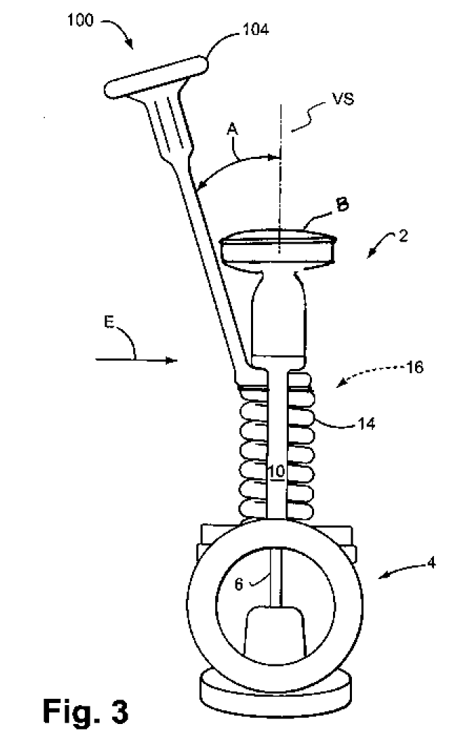

FIG. 3 shows tool 100 in operative engagement with valve assembly 2. Bifurcated foot 106 has been inserted into the gap that exists between spring 14 and pneumatic operator 8 to the point of straddling engagement with valve stem 6. Bifurcated foot is located above and in driving proximity to spring 14 and retaining cap 16 (FIG. 5). To enter into this relationship, tool 100 has been moved laterally such that bifurcated foot 106 enters the gap from a direction indicated by arrow E during approach prior to making contact with valve stem 6. It will be apparent that impacts applied to enlarged head 104 and transmitted to retaining cap 6 and subsequently to valve stem 6 will be in the direction of the valve (i.e., having mostly a downward component). This is the direction that frees the valve from its stuck position within housing 4 of valve assembly 2.

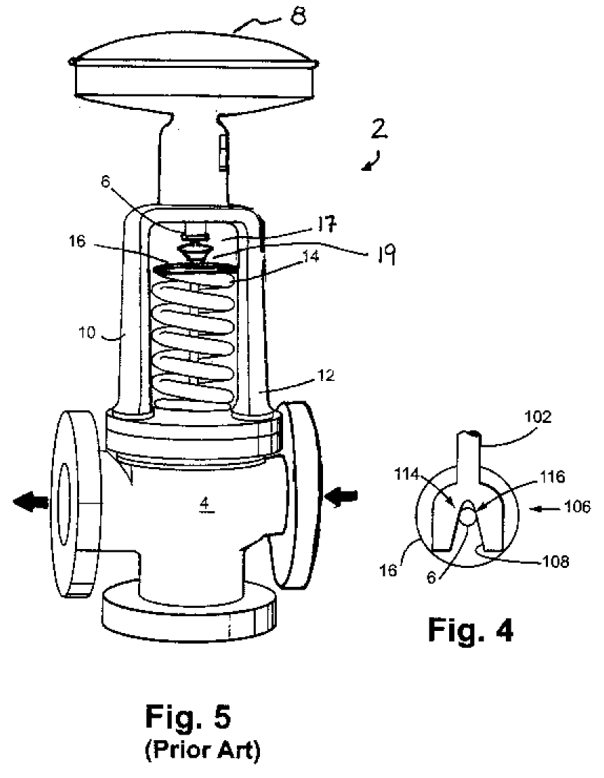

Turning now to FIG. 4, it will be seen that insertion of bifurcated foot 106 into straddling engagement of valve stem 6 results in contact of bifurcated foot 106 at two points of contact 114, 116. Positive contact is assured because of the V-shaped geometry of opening 108. At the same time, bifurcated foot 106 is centered about valve stem 6 and relative to retaining cap 16, provided that retaining cap 16 is in turn centered relative to valve stem 6. With manual pressure being applied to urge bifurcated foot 106 against valve stem 6, impacts delivered to tool 100 will be symmetrically imposed on valve stem 6. Therefore, valve stem 6 and its associated valve will be propelled downwardly in a manner that substantially avoids potential damage to various valve assembly components that might arise due to asymmetric forces.

The invention may be thought of both as comprising tool 100 and also a method of using tool 100. The method includes at least some of the steps of providing tool 100, inserting bifurcated foot 106 into straddling engagement with valve stem 6 above and in driving proximity relative to retaining cap 16, or to other enlargement of a valve stem in other valve assemblies by approaching valve stem 6 laterally when making contact between bifurcated foot 106 and valve stem 6, centering bifurcated foot 106 around valve stem 6 by urging bifurcated foot 106 against valve stem 6 such that valve stem 6 contacts the bifurcation (i.e., opening 108) at two points of contact 114 and 116, and applying at least one impact to enlarged head 104 in the direction of the valve such that force of the impact is transmitted to retaining cap 16 (or to other enlargements in other valves) of valve stem 6 and subsequently to valve stem 6 in the same direction that unseats the valve. However, the invention should not be limited to the above description, but only to the following claims. In particular, the invention is not limited to the exemplary valve shown in the preferred embodiment, as the invention can work on other types of valves in the same way.

I claim:

1. A method of freeing a valve in a valve assembly from a first stuck position, the valve assembly having a valve, a valve stem connected to the valve, and an enlargement disposed on the valve stem, the method comprising the steps of:
providing a tool having an elongated shaft, an enlarged head located at one end of the elongated shaft, and a bifurcated foot located at the opposite end of the elongated shaft;
inserting the bifurcated foot of the tool into straddling engagement with the valve stem in driving proximity relative to the enlargement of the valve stem; and
applying at least one impact to the enlarged head of the tool in the direction of the valve such that force of the impact is transmitted to the enlargement of the valve stem and subsequently to the valve stem to move the valve from its first stuck position.

2. The method according to claim 1, wherein said step of inserting the bifurcated foot of the tool into straddling engagement with the valve stem comprises the further step of centering the bifurcated foot of the tool around the valve stem by urging the bifurcated foot against the valve stem such that the valve stem contacts the bifurcation at two points of contact, whereby impacts delivered to the tool will be symmetrically imposed on the valve stem.

3. The method according to claim 1, wherein the bifurcation of said foot divides the bifurcated foot symmetrically.

4. The method according to claim 1, wherein said step of inserting the bifurcated foot of the tool into straddling engagement with the valve stem comprises the further step of approaching the valve stem laterally when making contact between the bifurcated foot of the tool and the valve stem.

5. The method according to claim 1, further comprising providing said bifurcated foot with a V shaped opening between said feet.

6. The method according to claim 1, further comprising providing said tool with an overall length of at least ten inches.

7. The method according to claim 1, further comprising providing said tool with an overall length of less than sixteen inches.

8. The method according to claim 1, further comprising providing said tool with an overall length in the range of ten inches to sixteen inches.

9. The method according to claim 1, further comprising providing an acute angle between a longitudinal axis of the tool and a plane containing the bifurcated foot of the tool.

10. The method according to claim 9, wherein said angle is in the range of 50 degrees to 80 degrees.

11. A method of freeing a valve in a valve assembly having a valve, a valve stem connected to the valve assembly between an upper valve guide and a lower valve seat, and a seat disposed on the valve stem between an upper valve guide and a valve seat, comprising the steps of:
providing a tool having an elongated shaft, a head located at one end of the elongated shaft, and a bifurcated foot located at the opposite end of the elongated shaft;
inserting the bifurcated foot of the tool into straddling engagement with the valve stem between the valve guide and the valve seat in driving proximity relative to the enlargement of the valve stem; and
applying pressure to the head of the tool in the direction of the valve such that the pressure is transmitted to the enlargement of the valve stem and subsequently to the valve stem in a direction that moves the valve.

12. The method according to claim 11, wherein said tool includes an enlarged head, and said pressure is applied by striking the enlarged head with an object.

13. The method according to claim 11, wherein said tool includes an enlarged head, and said pressure is applied by striking the enlarged head with a hammer.

14. The method according to claim 11, wherein said valve guide includes struts connecting the upper valve guide and the lower valve seat, and wherein said tool is configured to engage the valve stem in an area defined by said upper valve guide, said struts and said lower valve seat.

15. The method according to claim 1, further comprising providing said tool with an overall length in the range of ten inches to sixteen inches.

16. The method according to claim 1, further comprising providing said bifurcated foot as planar, and providing an acute angle between a longitudinal axis of the tool and a plane containing the bifurcated foot of the tool.

17. The method according to claim 9, wherein said angle is in the range of 50 degrees to 80 degrees.

18. A valve tool comprising:
an elongated shaft, an enlarged head located at one end of the elongated shaft, and a bifurcated foot located at the opposite end of the elongated shaft.

19. The valve tool of claim 18, wherein said valve tool is at least 10 inches in length and less than 16 inches in length.

20. The valve tool of claim 18, wherein said bifurcated foot is planar, and there is an acute angle between a longitudinal axis of the tool and a plane containing the bifurcated foot of the tool.
